(19) United States
(12) Patent Application Publication
(10) Pub. No.: US 2010/0118198 A1
(43) Pub. Date: May 13, 2010

(54) VIDEO QUALITY ADJUSTMENT SUPPORT UNIT, VIDEO SIGNAL PROCESSING UNIT, AND VIDEO QUALITY ADJUSTMENT SUPPORT METHOD

(75) Inventor: Junichi Usui, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, MEGURO-KU, TOKYO (JP)

(21) Appl. No.: 12/532,527

(22) PCT Filed: Mar. 23, 2007
(86) PCT No.: PCT/JP2007/055985

§ 371 Date: Sep. 22, 2009

(51) Int. Cl. H04N 5/14

(52) U.S. Cl. 348/576; 348/E05.062

(57) ABSTRACT

[PROBLEMS] To provide a video quality adjustment support unit capable of contributing to video quality improvement.

[MEANS FOR SOLVING PROBLEMS] Correction data of a video signal corresponding to a type of content and to a viewing condition for viewing the video signal is stored in a correction data storing device 30. Then, a content discriminating device 11a discriminate the type of content of the video signal, and a viewing condition data acquiring device 11b acquires viewing condition data. Then, a correction data extracting device 11c extracts correction data corresponding to the type of content and to the viewing condition data from the correction data storing device. Then, a supporting device 11d supports video quality adjustment of the video signal based on the correction data.

### TECHNICAL FIELD

This invention relates to a video quality adjustment support unit for supporting video quality adjustment of a video signal, a video signal processing unit, and a video quality adjustment support method.

### BACK GROUND

A video display device such as a TV set, a digital TV set or the like is provided in a typical home. Some of such video display devices are known by adjusting video quality using an illumination sensor. A video quality adjusting circuit described in Patent Document 1 acquires substantially the same video quality with respect to video signals having different driving voltages by means of sorting automatic tunings of the video quality depending on external environmental contrasts by the video signals.

[Patent Document 1] Japanese Published Patent Application No. H10-215425

### DISCLOSURE OF THE INVENTION

### Problem to be Solved by the Invention

However, when adjusting the video quality based on the external environmental illumination as described above, depending on the video content according to the video signal, there is no guarantee that the video quality adjusted corresponding to the environmental illumination is suitable for the video content. In detail, for example, when adjusting the video quality dark in the dark room for a movie, the image quality is not suitable for a sport video. Thus, a conventional adjustment based on the external environment is aimed at maintaining the performance of the video display device, and does not greatly contribute to the video quality improvement. This is an example of the problems to be solved by the present invention.

Accordingly, an object of the present invention is to provide a video quality adjustment support unit, a video signal processing unit, and a video quality adjustment support method for contributing to the video quality improvement.

### Means for Solving Problem

For attaining the object, according to claim 1 of the present invention, there is provided a video quality adjustment support unit to support video quality adjustment of a video signal for displaying contents, said support device including:

a correction data storing device for storing a plurality of correction data of the video signal corresponding to type of content and viewing condition of the video signal;

a content discriminating device for discriminating the type of content based on the video signal;

a viewing condition data acquiring device for acquiring viewing condition data indicating viewing condition;

a correction data extracting device for extracting the correction data corresponding to the type of the content discriminated by the content discriminating device and to the viewing condition data acquired by the viewing condition data acquiring device from the correction data storing device; and

a supporting device for supporting the video quality adjustment based on the correction data extracted by the correction data extracting device.

For attaining the object, according to claim 5 of the present invention, there is provided a video signal processing unit including:

the video quality adjustment support unit as claimed in any one of claims 1 to 4; and

a video quality adjusting unit for adjusting the video quality of the video signal based on the correction data used by the support device of the video quality adjustment support unit.

For attaining the object, according to claim 6 of the present invention, there is provided a video quality adjustment support method to support video quality adjustment of a video signal for displaying contents,

said method including the steps of:

storing a plurality of correction data of the video signal corresponding to type of content and to viewing condition of the video signal in a correction data storing device;

discriminating the type of the content based on the video signal

acquiring viewing condition data indicating the viewing condition;

extracting the correction data corresponding to the discriminated type of content and to the viewing condition from the correction data storing device; and

supporting the video quality adjustment based on the extracted correction data.

### BRIEF DESCRIPTION OF DRAWINGS

FIG. 1 A schematic view showing an example of a basic configuration of a video quality adjustment support unit and a video signal processing unit according to the present invention.

FIG. 2 A schematic view showing an example of a system configuration of a video display device to which the video quality adjustment support unit and the video signal processing unit of the present invention is applied.

FIG. 3 An explanatory view showing a relationship among types of contents, viewing condition data, and correction data.

FIG. 4 An explanatory view showing an example of data structure of the correction data.

FIG. 5 A flowchart showing an example of a video quality adjustment support processing executed by a control section in FIG. 2.

### Explanations of Letters or Numerals

1 video quality adjustment support unit

2 video signal

5 video signal processing unit

10 video display device

11a content discriminating device (control section)

11b viewing condition data acquiring device (control section)

11c correction data extracting device (control section)

11d supporting device (control section)

13 video quality adjusting unit (video processing section)

30 correction data storing device (memory section)

### BEST MODE FOR CARRYING OUT THE INVENTION

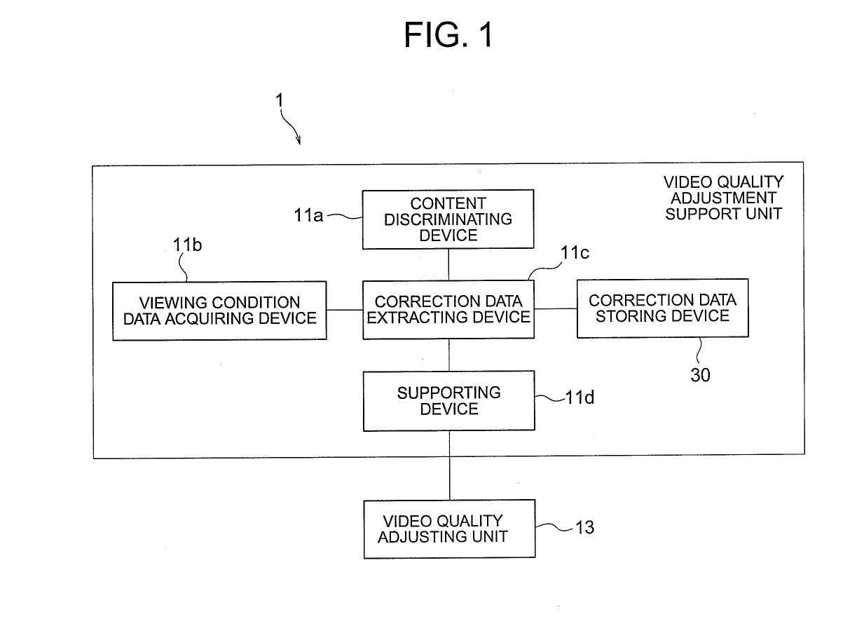

Hereafter, an embodiment of a video quality adjustment support unit and a video signal processing unit according to the present invention will be explained with reference to FIG. 1.

In FIG. 1, a video quality adjustment support unit 1 is to support video quality adjustment of a video signal for displaying contents, and includes: a correction data storing device 30 for storing a plurality of correction data of the video signal corresponding to type of content and viewing conditions of the video signal; a content discriminating device 11a for discriminating the type of content based on the video signal; a viewing condition data acquiring device 11b for acquiring viewing condition data indicating viewing condition; a correction data extracting device 11c for extracting the correction data corresponding to the type of content discriminated by the content discriminating device 11a and to the viewing condition data acquired by the viewing condition data acquiring device 11b from the correction data storing device 30; and a supporting device 11d for supporting the video quality adjustment based on the correction data extracted by the correction data extracting device 11c.

According to the video quality adjustment support unit 1, correction data of the video signal corresponding to type of the content and viewing condition of the video signal is stored in the correction data storing device 30. Then, the content discriminating device 11a discriminates the type of content based on the video signal, and the viewing condition data acquiring device 11b acquires viewing condition data. Then, the correction data extracting device 11c extracts the correction data corresponding to the type of content and to the viewing condition data from the correction data storing device 30. Then, the supporting device 11d supports the video quality adjustment based on the correction data.

Accordingly, because the type of content is discriminated, and the viewing condition is acquired, further, the video quality adjustment of the video signal is supported based on the correction data corresponding to both, the correction is supported so that the video signal is suitable for both the type of content and the viewing condition. Therefore, the video signal is corrected to the suitable video quality, and this adjustment contributes to the video quality improvement. Therefore, a conventional problem that the video signal is corrected corresponding to only the external environment, and the adjusted video quality is not suitable to the content, so that visibility is reduced can be solved.

Further, in the video quality adjustment support unit 1 described above, the viewing condition data acquiring device 11b acquires viewing condition data including illuminance data indicating illuminance of an environment in which the video signal is displayed.

According to the video quality adjustment support unit 1, because the viewing condition data acquiring device 11b acquires the viewing condition data including illuminance data indicating illuminance of an environment in which the video signal is displayed, the correction of the video signal is supported based on the correction data suitable for the illuminance of the environment and for the type of content, thereby the adjustment further contributes to the video quality improvement.

Further, in the video quality adjustment support unit 1 described above, the viewing condition data acquiring device 11b acquires the viewing condition data including at least one data item optionally selected from among a viewing distance, ambient noise, room temperature, an age of a viewer, or the like.

According to the video quality adjustment support unit 1, because the viewing condition data acquired by the viewing condition data acquiring device 11b includes one or more data items selected optionally, the viewing condition data acquiring device 11b can acquire the viewing condition selected optionally and the viewing condition data suitable for the type of content, so that the adjustment further contributes to the video quality improvement.

Further, in the video quality adjustment support unit 1 described above, the supporting device 11d supports the video quality adjustment so that the correction data is gradually changed to the currently extracted correction data extracted by the correction data extracting device 11c from the previously extracted correction data.

According to the video quality adjustment support unit 1, because the correction data is gradually changed from the currently extracted correction data from the previously extracted correction data, the video signal is prevented from changing rapidly due to the video quality adjustment corresponding to changes of the type of content, environmental condition, or the like, so that the video quality adjustment is done without giving uncomfortable feeling to a viewer.

Further, a video signal processing unit 5 includes: the video quality adjustment support unit 1 described above; and a video quality adjusting unit 13 for adjusting the video quality of the video signal based on the correction data which is used by the support device 11d of the video quality adjustment support unit 1.

According to the video signal processing unit 5, when the video quality adjustment support unit 1 supports the adjustment based on the correction data corresponding to both the type of content and the viewing condition, the video quality adjusting unit 13 adjusts the video quality of the video signal based on the correction data. Therefore, the corrected video signal is suitable for both the type of content and the viewing condition, so that the video signal is adjusted to the best suited video quality, and the adjustment contributes to the video quality improvement. Accordingly, the conventional problem that the video signal is corrected corresponding to only the external environment, and the adjusted video quality is not suitable to the content, so that visibility is reduced can be solved.

### EMBODIMENT

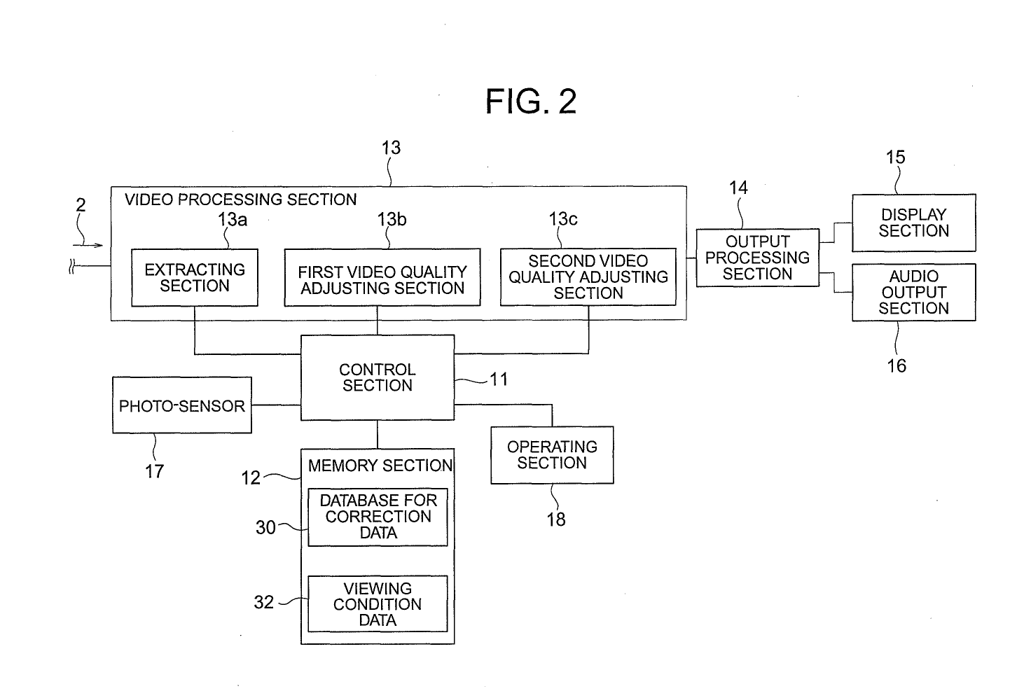

Hereunder, an embodiment of the video display device realizing the video signal processing unit having the video quality adjustment support unit described above will be explained with reference to FIGS. 2 to 5. Incidentally, the same reference numeral represents the same or substantially the same portion, part or component as the explanation described above.

In FIG. 2, a video display device 10 as a TV set such as PDP (plasma display panel), LCD(liquid crystal display) or the like includes a control section 11, a memory section 12, a video processing section 13, an output processing section 14, a display section 15, an audio output section 16, a photo-sensor 17, and an operating section 18. The video display device 10 adjusts the video quality of the video signal 2 for displaying contents and displays the video signal 2.

The control section 11 controls the whole video display device 10. A well-known microprocessor unit, a DSP (Digital Signal Processor) or the like is used for the control section 11. The control section 11 stores various programs for working as the content discriminating device, the viewing condition data acquiring device, the correction data extracting device, and the supporting device in a not-shown embedded memory. The control section 11 is connected to the memory section 12, the video processing section 13, the photo-sensor 17, and the operating section 18.

An EEPROM (electrically erasable and programmable ROM), a hard disc, or the like is used for the memory section 12. The memory section 12 includes a memory area for storing various data such as a database for correction data 30, viewing condition data 32 acquired from an outside, or the like. Incidentally, in this embodiment, the memory section 12 stores the database for correction data 30 suitable for a viewing distance of a viewer as a precondition. Further, in this case, in an initial setting of the video display device 10 or the like, the viewing distance is set by the operating section 18, and the database for correction data 30 corresponding to the viewing distance is selected from among a plurality of databases for correction data 30 which are previously stored in the memory section 12.

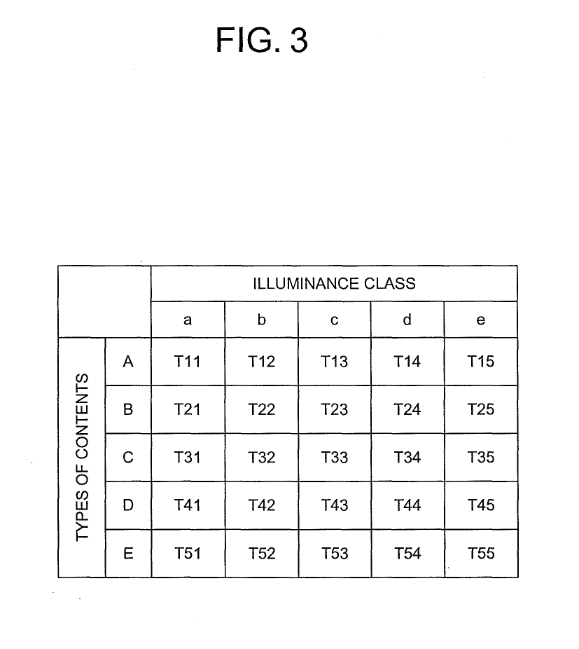

The database for correction data 30 includes a plurality of correction data 31. The database for correction data 30 manages the correction data 31 so that the correction data 31 corresponds to type of content indicated by the video signal 2 and to the viewing condition data 32. An example of a structure of the database for correction data 30 is shown in FIG. 3.

Incidentally, for simplifying the explanation, in FIG. 3, contents are classified into “A” to “E” as optional types such as sport, variety show, drama, movie, travel program, or the like, and the viewing condition data is illuminance. Further, with respect to contents types “A” to “E”, the illuminance is classified into illuminance classes “a” to “e”. Incidentally, the illuminance classes “a” to “e”, are, for example, under 100 (darkened room), 100 to 300 (dark room), 300 to 500 (bright room), 500 to 1000 (dark shop front), over 1000 (bright shop front), or the like.

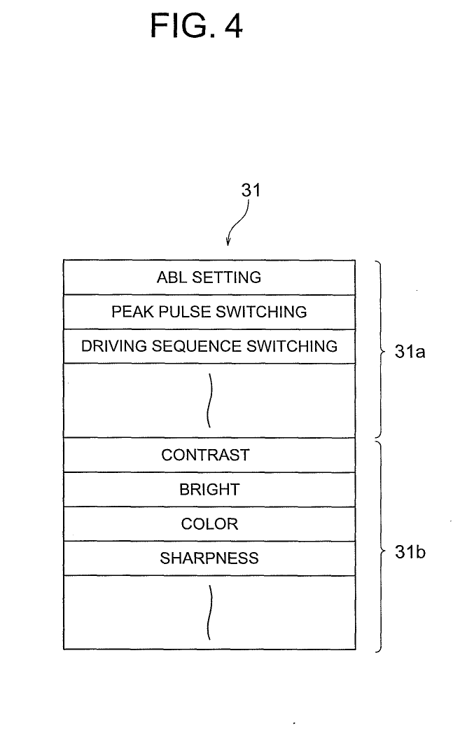

The correction data 31 corresponds to an array T11 to T55 of the contents types “A” to “E” and the illuminance classes “a” to “e”. As shown in FIG. 4, each of the correction data 31 includes a panel family correction item 31a and a signal processing family correction item 31b. The panel family correction item 31a includes various item data such as ABL setting, peak pulse switching, driving sequence switching, or the like. The signal processing family correction item 31b includes various item data such as contrast, bright, color, sharpness, or the like. Further, predetermined optional setting values corresponding to the types of contents “A” to “E” and the illuminance classes “a” to “e” are set to the item data. Incidentally, item data of the correction data 31 may be optionally determined according to the video quality adjustment.

The viewing condition data 32 includes a plurality of item data indicating viewing conditions for viewing the video signal 2. In this embodiment, item data is viewing distance and ambient illuminance, however, the item data may be set optionally. Further, when combining more item data, the better viewing condition may be recognized. Namely, the better correction data can be extracted, so that the video signal 2 is adjusted more suitably to the viewing condition.

The video processing section 13 works as the video quality adjusting unit 13 described above, and performs various processings (such as video quality adjustment) with respect to the video signal 2, and output to the output processing section 14. The video processing section 13 includes an extracting section 13a, a first video quality adjusting section 13b, and a second video quality adjusting section 13c. The video processing section 13 is realized by such as ASIC (application specific integrated circuit), DSP (digital signal processor), or electric circuit.

The extracting section 13a extracts video data for discriminating the type of content based on the video signal 2, and outputs to the control section 11. The first video quality adjusting section 13b adjusts the video quality of the video signal 2 based on various data such as contrast, bright, color, sharpness, or the like of the signal processing family correction item 31b set by the control section 11. The second video quality adjusting section 13c adjusts the video signal 2 with respect to the display section 15 based on various data such as ABL setting, peak pulse switching, driving sequence switching or the like of the panel family correction item 31a set by the control section 11.

The output processing section 14 outputs video data to the display section 15 based on the video signal 2 inputted from the video processing section 13, and outputs audio data to an audio output section 16. The display section 15 is connected to the output processing section 14, and displays the video data inputted therefrom. The audio output section 16 is connected to the output processing section 14, and amplifies the audio signal inputted therefrom, and outputs to an outside.

The photo-sensor 17 is connected to the control section 11, and works as the viewing condition data acquiring device. The well-known photo-sensor 17 detects the ambient illuminance of the video display device 10, and outputs an illuminance signal to the control section 11. Then, the control section 11 acquires a value of the inputted illuminance signal as environmental condition data.

The operating section 18 is connected to the control section 11, and includes a plurality of operation keys (not shown). When the operation keys are operated, the operating section 18 outputs operation data corresponding to the key operation to the control section 11. Then, the control section 11 analyzes an input operation of a user based on the inputted operation data, and performs a processing corresponding to its demand. Incidentally, because the user can input data via the operating section 18, various condition data such as a viewing distance, an age of a viewer or the like as the viewing condition data 32 may be inputted. Namely, depending on the embodiment, the operating section 18 also works as the viewing condition data acquiring device.

In the video display device 10 having such a configuration, when the video signal 2 is inputted into the video processing section 13, the video signal 2 is corrected based on the correction data set by the control section 11, and is outputted to the output processing section 14. Then, the video data of the video signal 2 is outputted to the display section 15, and the display section 15 displays the video data. Further, the audio data of the video signal 2 is outputted to the audio output section 16, and the audio output section 16 outputs the audio to the outside.

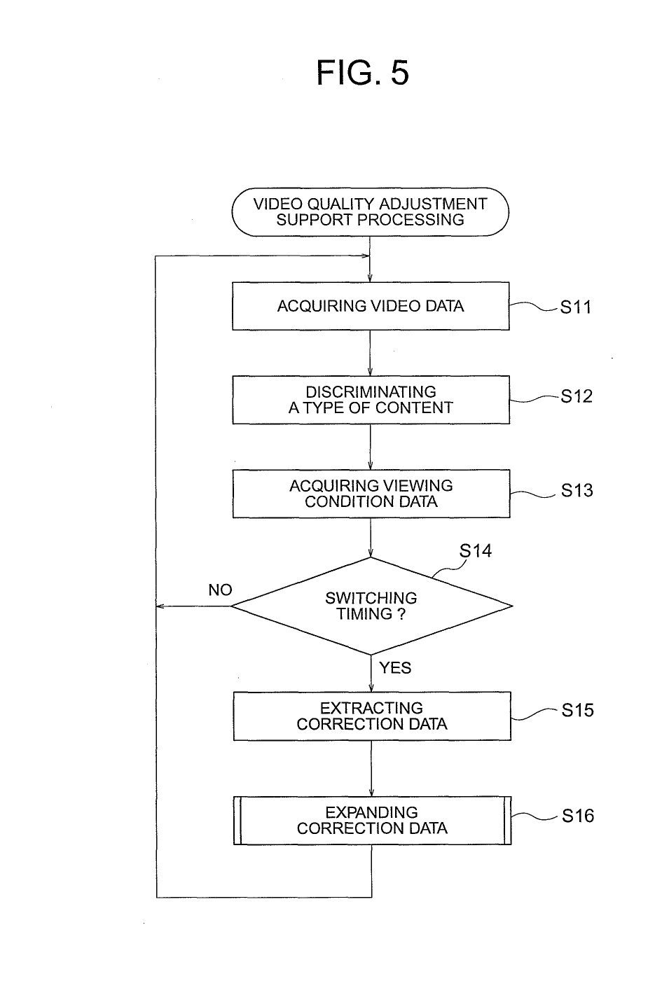

Next, an example of the video quality adjustment support method performed by the control section 11 will be explained with reference to a flowchart of FIG. 5.

When the control section 11 performs the video quality adjustment support processing in response to a start-up of the video display device 10, in step S11, the video data is acquired from the extracting section 13a of the video processing section 13, then, in step S12 (content discriminating device), the type of content is discriminated based on a result of analysis of the video data, and type data indicating the type is stored in the embedded memory or the like, then the step goes to S13.

Incidentally, as a way of discriminating the type of content, various ways may be adopted, such as discriminating based on time-oriented analysis result of the video data, discriminating with reference to an electronic program guide (EPG), discriminating by acquiring a program data of the displaying subject via the internet, discriminating based on the analysis result of the video data and the program data of EPG, or the like. Further, it is sufficient for a discrimination of the type of content to analyze the video data, however, by using the program data of EPG or the like, the type of content can be more precisely discriminated.

In step S13 (viewing condition data acquiring device), the illuminance signal inputted from the photo-sensor 17 is converted into the illuminance data, and the environmental data including the illuminance data is acquired and stored in the memory section 12, then step goes to S15. Incidentally, when acquiring a plurality of viewing conditions such as room temperature, audio, or the like, in addition to the illuminance, they are acquired as the viewing condition data 32.

In step 14, based on whether the type of content is changed by comparing the currently discriminated content with the previously discriminated content, or on whether a predetermined change is occurred in the viewing condition data 32, whether it is the switching timing of the correction data or not is judged. If judged that it is not the switching timing (“N” in S14), the step goes back to S11, and a series of steps is repeated. On the other hand, if judged that it is the switching timing (“Y” in S14), the type of content currently discriminated is stored in the memory section 12, and then step goes to S15.

In step 15 (correction data extracting device), the correction data 31 corresponding to the discriminated type of content and acquired illuminance data as the environmental data is extracted from the database for correction data 30 stored in the memory section 12, and then step goes to S16.

In step S16 (supporting device), the correction data is expanded, namely, respective item data of the panel family correction item 31a and the signal processing family correction item 31b extracted in step S15 are expanded and set to the first video quality adjusting section 13b and the second video quality adjusting section 13c of the video processing section 13. Then, step goes back to S11, and a series of steps is repeated.

Incidentally, in the correction data expanding process of this embodiment, because the correction data is gradually changed from the previous correction data to the current correction data, one or more correction data for transition corresponding to predetermined steps is generated based on the previous and current correction data for gradually changing the correction data via the predetermined steps. Then, the correction data for transition is switched and expanded corresponding to a transition speed, and finally, the current correction data is expanded. Thus, by expanding the correction data, the video signal 2 is prevented from being rapidly changed to be seen.

Next, an example of the video quality adjustment of the video signal 2 in the video display device 10 will be explained.

In the video display device 10, when the operating section 18 is operated by a viewer corresponding to the initial setting or the like, the inputted data corresponding to the operation is acquired as the viewing condition data 32 such as viewing distance, a physical feature of a viewer (eyesight, age, or the like) or the like and stored in the memory section 12 (memorizing process). Then, the database for correction data 30 corresponding to the viewing condition data 32 is set as a reference database in the video display device 10.

When the video signal 2 is inputted, the video display device 10 discriminates the type of content based on the video data thereof (discriminating process), and detects the ambient illuminance based on the illuminance signal inputted from the photo-sensor 17 to acquire the viewing condition data 32 (acquiring process). Then, the correction data 31 corresponding to the type of content and to the illuminance class of the viewing condition data 32 is extracted from the database for correction data 30 (extracting process), and the correction data is expanded in the video processing section 13 (supporting process). Thus, the video processing section 13 performs the video quality adjustment of the video signal 2 based on the suitable correction data, the video data is displayed on the display section 15 via the output processing section 14, and the audio data is outputted to the outside via the audio output section 16.

According to the video display device 10 as above described, because the type of content is discriminated, the viewing condition data 32 is acquired, and the video quality adjustment of the video signal 2 is supported based on the correction data corresponding to both, the adjustment is supported so that the video signal 2 is suitable for both the type of content and the viewing condition. Therefore, the video signal 2 is adjusted to the best video quality, and the adjustment contributes to the video quality improvement.

Incidentally, in the embodiment described above, the viewing distance is acquired from the operating section 18, and the illuminance is acquired from the photo-sensor 17 respectively as the viewing condition data 32. However, the present invention is not limited to this. Optionally determined data can be acquired as the viewing condition data 32.

For example, ambient voices via a microphone, and room temperature via a temperature sensor, and the like together with the illuminance are acquired. Then, the correction data 31 corresponding to the viewing condition data 32 including these item data and to the type of content is stored in the database for correction data 30. Thereby, the viewing condition data 32 suitable for the ambient atmosphere can be acquired. Therefore, the adjustment further contributes to the video quality improvement. Further, when the ambient voices are acquired as the viewing condition data 32, the video quality adjustment in view of the viewer's excitement can be performed.

Incidentally, in the embodiment described above, the video quality adjustment support unit and the video signal processing unit is realized by the video display device 10. However, the present invention is not limited to this. Various devices, for example, a device into which the video signal 2 is inputted such as an HDD (hard disk drive)/DVD (digital versatile disk) recorder, a STB (set-top box) or the like, or a device to process the video signal 2 can be adopted.

Although the present invention has been fully described by way of example with reference to the accompanying drawings, it is to be understood that various changes and modifications will be apparent to those skilled in the art.

1. A video quality adjustment support unit to support video quality adjustment of a video signal for displaying contents, said support device comprising:
a correction data storing device for storing a plurality of correction data of the video signal corresponding to type of content and viewing condition of the video signal;
a content discriminating device for discriminating the type of content based on the video signal;
a viewing condition data acquiring device for acquiring viewing condition data indicating viewing condition;
a correction data extracting device for extracting the correction data corresponding to the type of the content discriminated by the content discriminating device and to the viewing condition data acquired by the viewing condition data acquiring device from the correction data storing device; and
a supporting device for supporting the video quality adjustment based on the correction data extracted by the correction data extracting device.

2. The support unit as claimed in claim 1,
wherein the viewing condition data acquiring device is a device for acquiring the viewing condition data including illuminance data indicating ambient illuminance of a place in which the video signal is displayed.

3. The support unit as claimed in claim 1,
wherein the viewing condition data acquiring device is a device for acquiring the viewing condition data including at least one item data selected optionally from a viewing distance, an ambient voice, room temperature, an age of a viewer, and the like.

4. The support unit as claimed in claim 1,
wherein the supporting device is a device for supporting the video quality adjustment so that the correction data is gradually changed from the currently supported data to correction data currently extracted by the correction data extracting device.

5. A video signal processing unit comprising:
the video quality adjustment support unit as claimed in claim 1; and
a video quality adjusting unit for adjusting the video quality of the video signal based on the correction data used by the support device of the video quality adjustment support unit.

6. A video quality adjustment support method to support video quality adjustment of a video signal for displaying contents,
said method comprising the steps of:
storing a plurality of correction data of the video signal corresponding to type of content and to viewing condition of the video signal in a correction data storing device;
discriminating the type of content based on the video signal;
acquiring viewing condition data indicating the viewing condition;
extracting the correction data corresponding to the discriminated type of content and to the viewing condition from the correction data storing device; and
supporting the video quality adjustment based on the extracted correction data.
